(19) United States
(12) Patent Application Publication
(10) Pub. No.: US 2026/0116084 A1
(43) Pub. Date: Apr. 30, 2026

(54) LIQUID SUPPLY APPARATUS AND SYSTEM

(71) Applicant: CANON KABUSHIKI KAISHA, Tokyo (JP)

(72) Inventors: YUJIRO ISHIDA, Tokyo (JP); RYUTARO TAKAHASHI, Tokyo (JP); SHU KURIHARA, Tokyo (JP); KEIICHI KITANO, Kanagawa (JP); KENTA IIMURA, Tokyo (JP); RYOHEI MARUYAMA, Kanagawa (JP); KOHEI FUKUI, Tokyo (JP); MASAKAZU NAGASHIMA, Kanagawa (JP); HIROMASA YONEYAMA, Kanagawa (JP); TAKUYA HANE, Kanagawa (JP); MASAHARU UEDA, Kanagawa (JP); SEIJI SUZUKI, Kanagawa (JP)

(21) Appl. No.: 19/365,064

(22) Filed: Oct. 21, 2025

(30) Foreign Application Priority Data
Oct. 29, 2024 (JP) 2024-190070

(51) Int. Cl. B41J 2/20; B01F 29/34; B01F 101/35; B41J 2/175

(52) U.S. Cl. CPC B41J 2/20; B01F 29/34; B41J 2/17513; B41J 2/17553; B01F 2101/35; B41J 2002/17516

(57) ABSTRACT

A liquid supply apparatus includes a liquid container including a containing part having flexibility, and a connecting part provided at an end portion of the containing part, a channel connected to the connecting part and configured to flow a liquid out of the liquid container, a rotation unit configured to rotate the containing part with respect to the connecting part, a regulating unit configured to regulate displacement of the connecting part in a direction crossing a connection direction between the connecting part and the channel.

### BACKGROUND

### Field of the Technology

The present disclosure relates to a liquid supply apparatus.

### Description of the Related Art

A liquid containing a substance with sedimentability sometime needs to be stirred to disperse the sediment before use. For example, in a printing apparatus that performs printing by discharging liquid ink to a print medium, when using ink such as pigment ink or metallic ink, the stirring is needed to disperse the sediment in some cases. International Publication No. WO 2017/217001 discloses an apparatus that stirs ink by rotating an ink cartridge.

In a configuration that rotates an ink cartridge, like International Publication No. WO 2017/217001, a member such as a tube that forms a channel of ink to an ink supply destination is deformed along with the rotation of the ink cartridge. If the rotation of the ink cartridge is repeated, the member such as a tube is also repetitively deformed. The member such as a tube may be fatigued and need to be exchanged early.

### SUMMARY

The present disclosure provides a technique of suppressing fatigue of a member that forms a channel.

According to one aspect of the present disclosure, there is provided a liquid supply apparatus comprising: a liquid container including a containing part having flexibility, and a connecting part provided at an end portion of the containing part; a channel connected to the connecting part and configured to flow a liquid out of the liquid container; a rotation unit configured to rotate the containing part with respect to the connecting part; and a regulating unit configured to regulate displacement of the connecting part in a direction crossing a connection direction between the connecting part and the channel.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view of a printing system according to the embodiment of the present disclosure;

FIG. 2 is a perspective view of a liquid supply apparatus provided in the printing system shown in FIG. 1;

FIG. 3 is an explanatory view showing the internal structure of the liquid supply apparatus shown in FIG. 2;

FIG. 4 is a perspective view of a liquid container;

FIG. 5 is a perspective view of a tray;

FIG. 6 is a perspective view of a tray;

FIG. 7 is a perspective view of a lock mechanism;

FIGS. 8A to 8C are operation explanatory views of the lock mechanism shown in FIG. 7;

FIG. 9 is a perspective view of a tray on which the liquid container is placed;

FIG. 10 is a front view of the connecting part of the liquid container;

FIG. 11 is a view showing the tray with the liquid container placed thereon viewed from the side of a rear wall part;

FIG. 12 is a perspective view of the periphery of a holding part of the tray;

FIG. 13 is a perspective view of a connecting unit;

FIGS. 14A and 14B are operation explanatory views of a rotation unit;

FIGS. 15A and 15B are operation explanatory views of a rotation unit; and

FIG. 16 is a view showing the posture of the liquid container at the maximum rotation position.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### <Configuration of System>

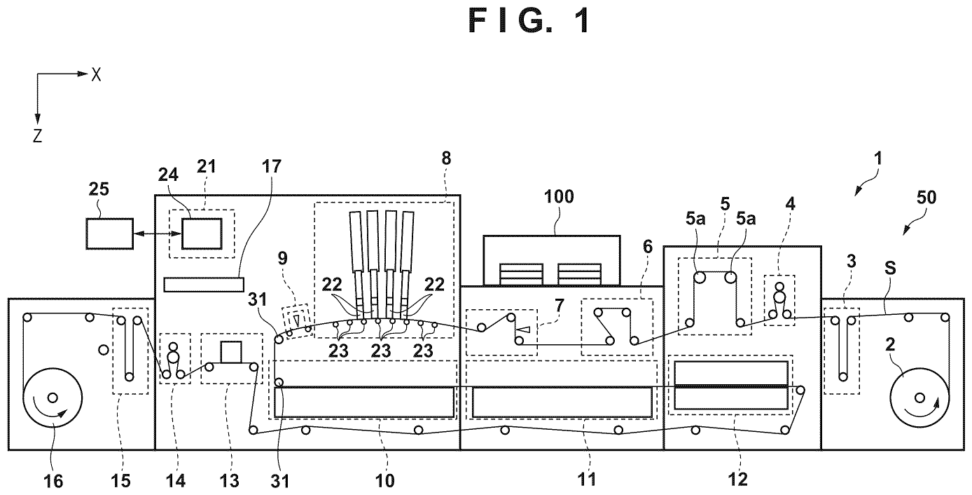

FIG. 1 is a schematic view of a printing system 1 according to the embodiment of the present disclosure. The printing system 1 includes a liquid supply apparatus 100 and a liquid discharge apparatus 50. The liquid discharge apparatus 50 discharges a liquid to a print medium, and the liquid supply apparatus 100 supplies the liquid to the liquid discharge apparatus 50. In this embodiment, the liquid supply apparatus 100 supplies ink to the liquid discharge apparatus 50, and the liquid discharge apparatus 50 discharges the ink to a print medium by an inkjet method, thereby printing an image. The printing system 1 according to this embodiment is a system that prints an image by discharging ink to a continuous sheet wound in a roll, and is a high-speed line printer capable of performing high-speed printing.

Note that “print” includes not only forming significant information such as characters and graphics but also forming images, figures, patterns, and the like on print media in a broad sense, or processing media, regardless of whether the information is significant or insignificant or whether the information is visualized so that a human can visually perceive it. In addition, although in this embodiment, sheet-like paper is assumed as a “print medium”, cloth, a plastic film, and the like may also be used.

In the drawings, arrows X, Y, and Z indicate directions crossing each other. In this embodiment, the arrows X and Y indicate horizontal directions that are orthogonal to each other, and the arrow Z indicates the vertical direction. The Z direction is the up/down direction (height direction) of the printing system 1. The X direction is the longitudinal direction (depth direction) of the printing system 1. The Y direction is the widthwise direction of the printing system 1.

The printing system 1 includes a roll unwinding unit 2, a dancer unit 3, a main conveyance unit 4, a meandering correction unit 5, a conveyance detection unit 6, a mark sensor unit 7, and a printing unit 8. The printing system 1 further includes, at the subsequent stage of the printing unit 8, a scanner unit 9, a drying unit 10, a drying unit 11, a cooling unit 12, a scanner unit 13, a main conveyance unit 14, a dancer unit 15, a roll winding unit 16, and a maintenance tray 17.

A sheet S that is a print medium is conveyed from the roll unwinding unit 2 to the roll winding unit 16 along a conveyance path indicated by a solid line in FIG. 1, and undergoes various kinds of processing by the above-described units in the process of conveyance. In the following description, “upstream side” and “downstream side” mean the upstream side and the downstream side in the conveyance direction of the sheet S. Relatively speaking, the side of the roll unwinding unit 2 is the upstream side, and the side of the roll winding unit 16 is the downstream side.

The roll unwinding unit 2 is a feeding unit configured to hold the sheet S wound in a roll and supply it to the downstream side. The roll unwinding unit 2 stores an unwinding roll, pulls out the sheet S, and supplies it. Note that FIG. 1 shows one roll of the sheet S, but the number of rolls is not limited to one, and two or three or more rolls may be used. In this case, the sheet S may selectively be pulled out from the plurality of rolls and supplied.

The dancer unit 3 is a unit configured to apply a predetermined tension to the sheet S between the roll unwinding unit 2 and the main conveyance unit 4. The main conveyance unit 4 conveys the sheet S to the unit on the downstream side and applies a predetermined tension to the sheet in cooperation with the main conveyance unit 14. The main conveyance unit 4 includes a plurality of rollers that are rotated by a motor (not shown) serving as a driving source, and conveys the sheet S while applying the tension to the sheet S.

The meandering correction unit 5 is a unit configured to correct meandering of the sheet S in the widthwise direction when conveying the sheet S with the tension imparted thereto. The meandering correction unit 5 includes meandering correction rollers 5a, and a meandering detection sensor (not shown) that detects meandering of the sheet S. The meandering correction rollers 5a can change the tilt of the sheet S by a motor (not shown), and correct meandering of the sheet S based on the measurement result of the meandering detection sensor. At this time, the meandering correction function can be enhanced by causing the sheet S to wind around the meandering correction rollers 5a. The meandering correction unit 5 can return the conveyance direction of the meandering sheet S to the normal conveyance direction.

The conveyance detection unit 6 is a unit configured to detect the tension when the sheet S with the tension applied is conveyed between the main conveyance unit 4 and the main conveyance unit 14. Also, the conveyance detection unit 6 is a unit configured to detect the speed of the sheet S to control the print timing of the printing unit 8. The mark sensor unit 7 is a unit configured to detect a mark printed on the sheet S in advance to control the print timing of the printing unit 8.

The printing unit 8 is a unit configured to perform printing on the conveyed sheet S, and includes a plurality of printheads 22 that discharge ink from above to the sheet S. The conveyance path of the sheet S in the printing unit 8 is defined by a plurality of guide rollers 23 arranged to form an arc shape projecting upward. A predetermined tension is applied to the sheet S, thereby ensuring clearance between the sheet S and each printhead 22.

Each printhead 22 is a full line head. However, the printing method may be the method of a serial printer that repetitively performs print scanning of discharging ink while moving the printhead in the main scanning direction and intermittent conveyance of the sheet.

The plurality of printheads 22 are arranged along the conveyance direction of the sheet S. In this embodiment, in addition four color inks, that is, Bk (black), Y (yellow), M (magenta), and C (cyan) inks, a reaction liquid and three spot color inks are discharged. That is, a total of eight printheads 22 are provided.

Note that the number of colors is not limited to four, and the number of printheads 22 is not limited to eight. As for an ink discharge element provided in the printhead 22, a method using a heat generating element, a method using a piezoelectric element, a method using an electrostatic element, a method using a MEMS element, or the like can be employed. Each ink is supplied from the liquid supply apparatus 100 to a corresponding one of the printheads 22 via a tube.

The scanner unit 9 is a unit configured to read an image printed on the sheet S by the printing unit 8 and detect the deviation and density of the image. The detection result of the scanner unit 9 is used for correction and, for example, used for position correction and tone correction.

The drying unit 10 and the drying unit 11 are units configured to decrease liquid components contained in the ink applied to the sheet S by the printing unit 8 and increase the fixing properties between the sheet S and the ink. The drying unit 11 is arranged on the downstream side of the drying unit 10. The drying unit 10 and the drying unit 11 heat the printed sheet S and dry the applied ink. The drying unit 10 and the drying unit 11 apply hot air at least from the ink application surface side to the passing sheet S, thereby drying the ink application surface. To increase the drying efficiency, the hot air may be applied not only to the ink application surface but also to the opposite side of the ink application surface. Note that as the drying method, in addition to the method of applying hot air, a method of irradiating the surface of the sheet S with an electromagnetic wave (ultraviolet rays, infrared rays, or the like) or a conduction heat transfer method using contact of a heating element may be combined.

Winding guide rollers 31 are rollers that block the influence of hot air generated by the drying unit 10 on the printing unit 8. On the downstream side of the printing unit 8, the surface of the sheet S on the opposite side of the ink application surface is wound around the winding guide roller 31 at a predetermined winding angle. In this embodiment, two winding guide rollers 31 are arranged between the scanner unit 9 and the drying unit 10, and the sheet S is folded back to be substantially parallel on the upper and lower sides of the apparatus. The drying unit 10 is arranged on the lower side of the printing unit 8, and the drying unit 11 is arranged on the lower side of the conveyance detection unit 6 and the mark sensor unit 7.

The cooling unit 12 cools the sheet S on which the ink is fixed by the drying unit 10 and the drying unit 11, thereby solidifying the softened ink and suppressing a temperature change of the sheet S after that. Inside the cooling unit 12, air at a temperature lower than that of the sheet S is applied at least from the ink application surface side to the passing sheet S, thereby cooling the ink application surface of the sheet S. Note that the cooling method is not limited to the method of applying air, and a conduction heat transfer method using contact of a heat dissipation member may be used, and these methods may be combined. Also, to efficiently solidify the ink, air may be applied to both surfaces of the sheet S.

The scanner unit 13 is a unit configured to read a test image printed on the sheet S by the printing unit 8 before actual printing and detect the deviation and density of the image. The detection result of the scanner unit 13 is used for correction in actual printing.

The main conveyance unit 14 is a unit that functions by operating together with the main conveyance unit 4, and is a unit configured to convey the sheet S while applying a tension to the sheet S and adjust the tension of the sheet S. The main conveyance unit 14 includes a plurality of rollers that are driven by a motor (not shown) and thus rotated. The tension of the sheet S is adjusted by a clutch (not shown) between the motor and the rollers based on a tension value detected by a tension control unit (not shown).

Note that as an additional component to adjust the tension of the sheet S, a component that control the speed of the main conveyance unit 14 based on the detection result of the conveyance detection unit 6 may be added. As a method of implementing this configuration, one of a torque control method of controlling the value of a torque transmitted from the clutch and a speed control method of controlling the roller sped of the main conveyance unit 14 can be used. Alternatively, the two methods may selectively be used in accordance with the purpose, or both methods may be used simultaneously.

The dancer unit 15 is a unit configured to apply a predetermined tension to the sheet S between the main conveyance unit 14 and the roll winding unit 16. The roll winding unit 16 is a unit configured to wind the sheet S after printing around a winding core. Note that FIG. 1 shows one roll to wind, but the number of rolls may be two or three or more. A plurality of winding cores may be prepared, and the winding core to be used for winding may selectively be switched to collect the sheet S.

Note that as the processing of the sheet S after printing, instead of winding the sheet S around the winding core, the sheet S may be cut using a cutter, and the cut sheet S may be stacked.

The maintenance tray 17 is a maintenance mechanism that recovers the discharge performance of each printhead 22. The maintenance mechanism may include, for example, a cap member that protects the liquid discharge surface of the printhead 22, a wiper member that wipes the liquid discharge surface, and a suction member that sucks ink in the printhead 22 from the liquid discharge surface by negative pressure suction.

The liquid supply apparatus 100 is an apparatus that holds a liquid container (ink tank) for storing ink to be discharged from the printhead 22, and supplies the ink to the printhead 22. The liquid supply apparatus 100 according to this embodiment is arranged at a position on the upstream side of the printing unit 8, but the arrangement is not limited to this position. In FIG. 1, the liquid supply apparatus 100 is arranged on the upper side of a housing including the conveyance detection unit 6, the mark sensor unit 7, and the drying unit 11.

A control unit 21 is an electronic circuit that controls the units of the printing system 1, and includes at least one processor, and at least one storage device that stores programs to be executed by the processor. The storage device is, for example, a semiconductor memory. More specifically, the control unit 21 includes a CPU, a storage device, an external interface, and an operation unit 24 used by a user for input/output. The operation unit 24 is, for example, a touch panel. The control unit 21 controls the operation of the printing system 1 based on an instruction input via the operation unit 24 or an instruction from a host device 25 such as a host computer connected via the external interface.

### <Liquid Supply Apparatus>

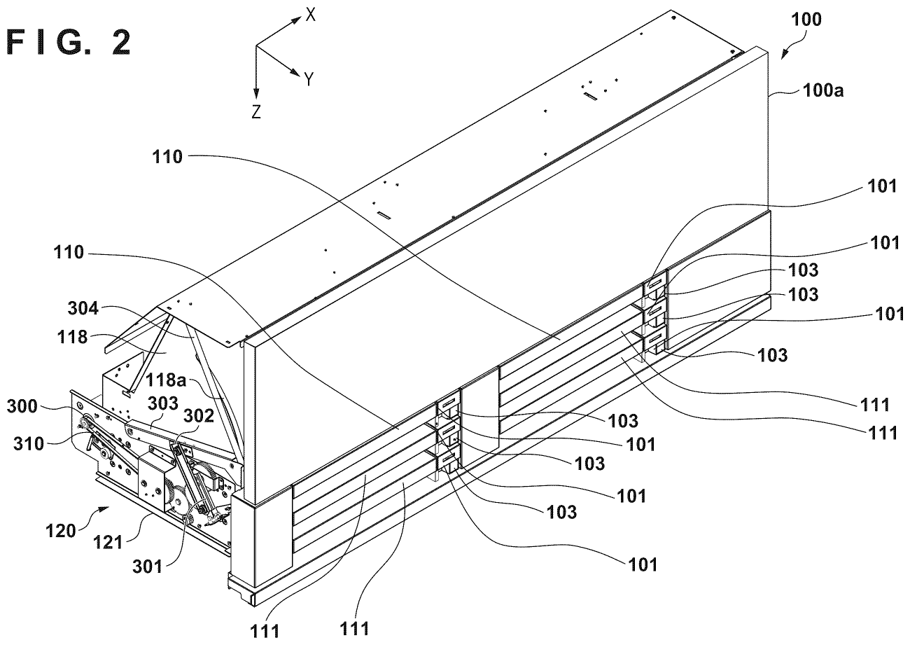

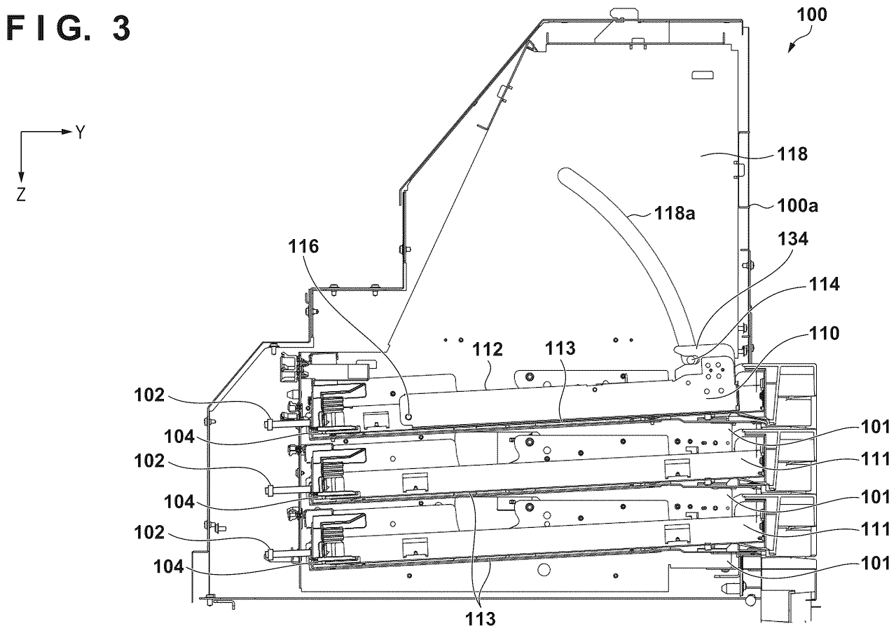

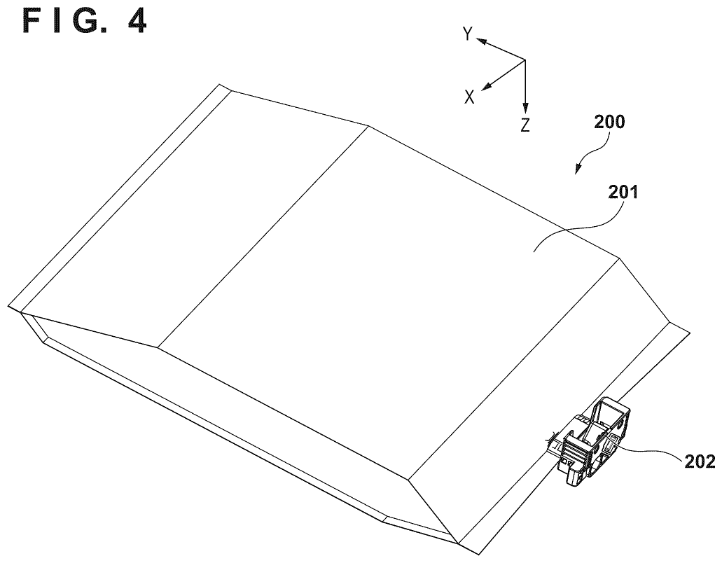

The liquid supply apparatus 100 will be described. FIG. 2 is a perspective view of the liquid supply apparatus 100, and FIG. 3 is an explanatory view showing the internal structure of the liquid supply apparatus 100. A main body 100a of the liquid supply apparatus 100 includes a plurality of storage units 101 each capable of storing a liquid container 200 (FIG. 4) that stores ink. In this embodiment, six storage units 101 are provided. The six storage units 101 are arranged in three stages in the Z direction and two columns in the X direction. Each storage unit 101 is a space having a flat rectangular parallelepiped shape in which the lengths in the X and Y directions are longer than the length in the Z direction. Note that in this embodiment, the length of the storage unit 101 in the Y direction is longer than the length in the X direction. A connecting unit 104 connected to the liquid container 200 is provided at an end portion on the far side of each storage unit 101 (an end portion in the Y direction).

A tray 110 or a tray 111 is detachably attached to each storage unit 101. In this embodiment, the liquid container 200 is placed on the tray 110 or the tray 111 and detachably stored in the storage unit 101. In the storage units 101 of three stages, the tray 110 is attached to the storage unit 101 of the uppermost stage, and the trays 111 are attached to the storage units 101 of the middle and lower stages. Hence, two trays 110 and four trays 111 are used. The trays 110 and 111 basically have the same structure. The tray 110 has a structure for stirring ink in the liquid container 200, as will be described later.

Each storage unit 101 is also provided with an operation member 103 that regulates detachment of the tray 110 or the tray 111 and locks the tray to a corresponding storage unit 101. The operation member 103 is provided to be slidable in the X direction, and the user can operate this.

### (Liquid Container)

The liquid container 200 will be described. FIG. 4 is a perspective view of the liquid container 200. The liquid container 200 includes a containing part 201 that stores ink, and a connecting part 202 connected to the connecting unit 104 of the storage unit 101. The containing part 201 is a bag-type ink pack made of a material having flexibility. As for the flexibility of the containing part 201, it may only be deflected by its own weight, or may hold the shape against its own weight and only be deflected when a load larger than its own weight is applied.

The containing part 201 is formed into a bag shape by welding sheets forming the upper and lower surfaces and sheets forming gusset portions on the left and right sides (the side portions in the X direction) to each other, thereby forming a flexible tank that has a rectangular shape in a planar view and stores a liquid. The material of the containing part 201 is, for example, a material having a multiple layer structure such as PET, and the multiple layer structure may include an aluminum layer.

The connecting part 202 is provided at an end portion of the containing part 201 in the Y direction and at the central portion in the X direction. The connecting part 202 is detachably connected to the connecting unit 104 and forms an ink channel between the containing part 201 and the connecting unit 104.

### (Trays)

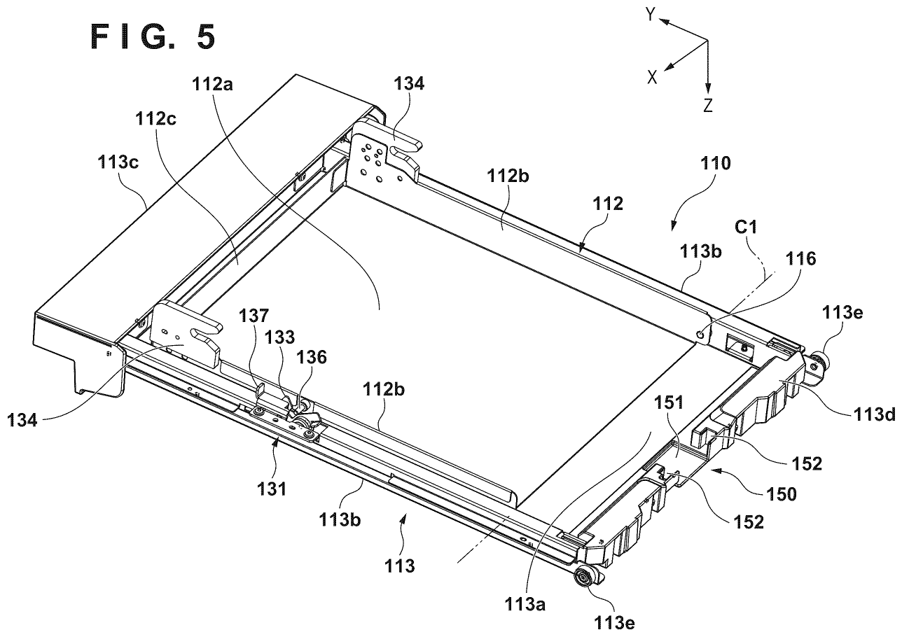

The trays 110 and 111 will be described. FIG. 5 is a perspective view of the tray 110. The tray 110 includes a tray main body 113. The tray main body 113 is a member that includes a bottom wall part 113a, left and right side wall parts 113b, a front wall part 113c, and a rear wall part 113d and has a shallow rectangular box shape with its top part open. A roller 113e is rotatably supported on each side wall part 113b. Insertion/removal of the tray 110 into/from the storage unit 101 can smoothly be performed by rolling of the rollers 113e.

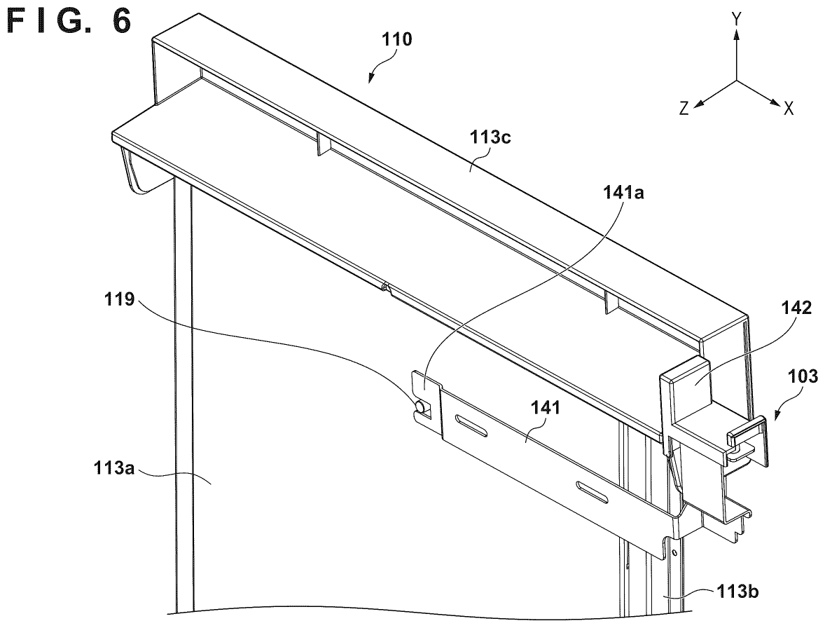

FIGS. 2 and 6 will be referred to. FIG. 6 is a perspective view of the tray 110, and shows a part of the bottom surface of the bottom wall part 113a. An engaging part 119 that engages with the operation member 103 is provided on the bottom surface of the bottom wall part 113a of the tray main body 113. The engaging part 119 according to this embodiment is a projection having a columnar shape. The operation member 103 includes an arm member 141 with a C-shaped engaging part 141a that engages with the engaging part 119, and a knob part 142 that the user can grip.

The arm member 141 is a plate-shaped member extended in the X direction along the bottom surface of the bottom wall part 113a, and is connected to the knob part 142. FIG. 6 shows a state in which the engaging parts 119 and 141a engage with each other, and movement of the tray 110 in the Y direction (that is, detachment from the storage unit 101) is regulated. When the knob part 142 is moved in the X direction from the state shown in FIG. 6, the arm member 141 is displaced in the X direction, and the engagement between the engaging part 119 and the engaging part 141a can be canceled. The tray 110 can thus be extracted from the storage unit 101. This engagement mechanism can prevent the tray 110 from being unintentionally removed from the storage unit 101.

Referring back to FIG. 5, a placement member 112 is mounted on the tray main body 113. The placement member 112 is a member that includes a bottom wall part 112a overlaid on the bottom wall part 113a, left and right side wall parts 112b located inside the left and right side wall parts 113b, and a front wall part 112c located inside the front wall part 113c and has a shallow rectangular box shape with its top portion and rear end portion open. The tray 110 according to this embodiment has a double tray structure in which the tray main body 113 is the outer tray, and the placement member 112 is the inner tray.

The bottom wall part 112a of the placement member 112 is shorter than the bottom wall part 113a of the tray main body 113 in the Y direction, and the edge (rear edge) of the bottom wall part 112a in the Y direction is apart from the rear wall part 113d of the tray main body 113. The placement member 112 is rotatably supported by the tray main body 113 via a shaft 116. The left and right side wall parts 112b are supported by the left and right side wall parts 113b of the tray main body 113 via the shafts 116 (FIG. 5 shows only one shaft 116). The placement member 112 can rotate, with respect to the tray main body 113, about a rotation centerline C1 passing through the shafts 116 as the rotation center. In this viewpoint, the placement member 112 can also be called a movable member or a rotation member. FIG. 5 shows a state in which the placement member 112 is located at an initial position with respect to the tray main body 113. At the initial position, the bottom surface of the bottom wall part 112a of the placement member 112 abuts against the upper surface of the bottom wall part 113a of the tray main body 113 and these are overlaid in the Z direction.

An engaging part 134 is fixed to each side wall part 112b of the placement member 112. A rotation unit 120 to be described later inputs a rotation biasing force to the engaging part 134, and the placement member 112 thus rotates. The engaging part 134 has a C shape open to one side (rear side) in the Y direction.

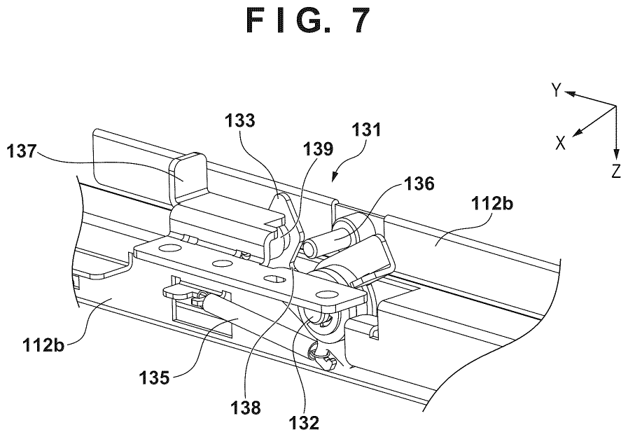

The tray main body 113 is also provided with a lock mechanism 131 that locks the placement member 112 to the tray main body 113 and regulates its rotation from the initial position. The lock mechanism 131 operates in synchronism with attachment/detachment of the tray 110 to/from the storage unit 101. When attaching the tray 110 to the storage unit 101, the lock mechanism 131 allows the placement member 112 to rotate. When the tray 110 is detached from the storage unit 101, the lock mechanism 131 regulates rotation of the placement member 112. FIG. 7 is a perspective view of the lock mechanism 131.

The lock mechanism 131 includes a rotation shaft 132 provided on one side wall part 113b of the tray main body 113, a lock member 133 rotatably supported by the tray main body 113 via the rotation shaft 132, and a biasing member 135 that biases the lock member 133 in a rotation direction RR. The biasing member 135 is an elastic member such as a coil spring connected between the side wall part 113b and the lock member 133. An unlock member 137 is fixed to the storage unit 101, and an engaging part 136 is provided on the placement member 112. The engaging part 136 is a shaft member projecting from the side wall part 112b in the X direction. The lock member 133 includes a lock part 138 having a roller shape engaging with the engaging part 136, and an abutment part 139 having a shape of a concave part abutting against the unlock member 137.

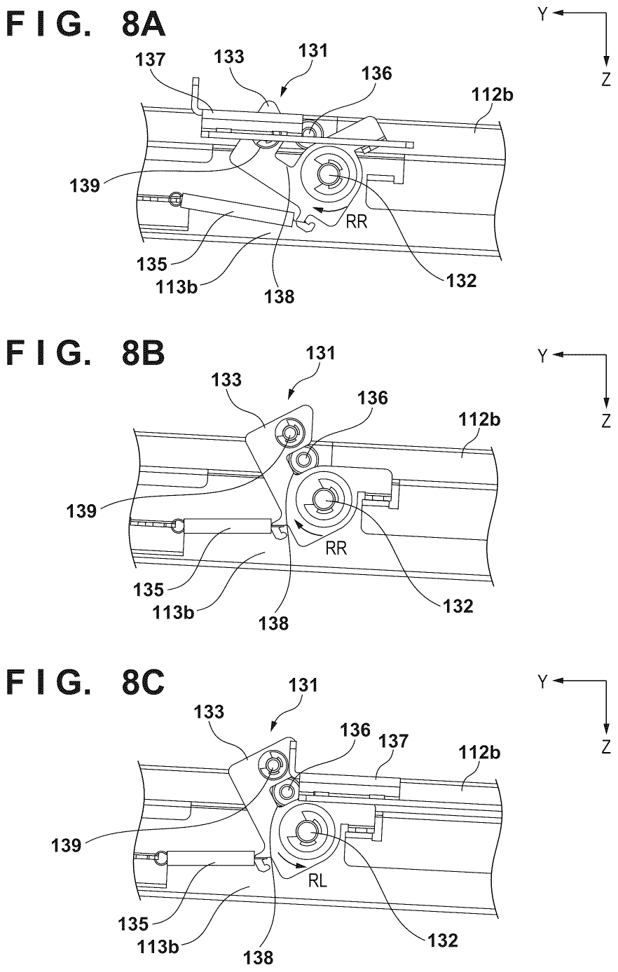

FIGS. 8A to 8C are operation explanatory views of the lock mechanism 131. FIG. 8A shows the state of the lock mechanism 131 in a state in which the tray 110 is stored in the storage unit 101. The lock member 133 receives a biasing force to rotate in the rotation direction RR from the biasing member 135, and the abutment part 139 contacts the unlock member 137. The abutment part 139 contacts the unlock member 137 to impede engagement between the lock part 138 and the engaging part 136. The placement member 112 is in an unlocked state, that is, in a state in which the placement member 112 can rotate from the initial position with respect to the tray main body 113.

FIG. 8B shows the state of the lock mechanism 131 in a state in which the tray 110 is extracted from the storage unit 101. The lock member 133 receives the biasing force to rotate in the rotation direction RR from the biasing member 135, and the lock part 138 engages with the engaging part 136. When the lock part 138 engages with the engaging part 136, the placement member 112 is in a locked state, that is, in a state in which rotation with respect to the tray main body 113 is regulated and the placement member 112 is locked to the initial position.

FIG. 8C shows the state of the lock mechanism 131 in a halfway state in which the tray 110 is being inserted into the storage unit 101. The lock member 133 receives the biasing force to rotate in the rotation direction RR from the biasing member 135, and the lock part 138 engages with the engaging part 136. Along with the insertion operation of the tray 110 into the storage unit 101, the abutment part 139 contacts the unlock member 137, and the lock member 133 rotates in a rotation direction RL. When the tray 110 is stored in the storage unit 101, the lock mechanism 131 is set in the state shown in FIG. 8A, and the engagement between the lock part 138 and the engaging part 136 is canceled.

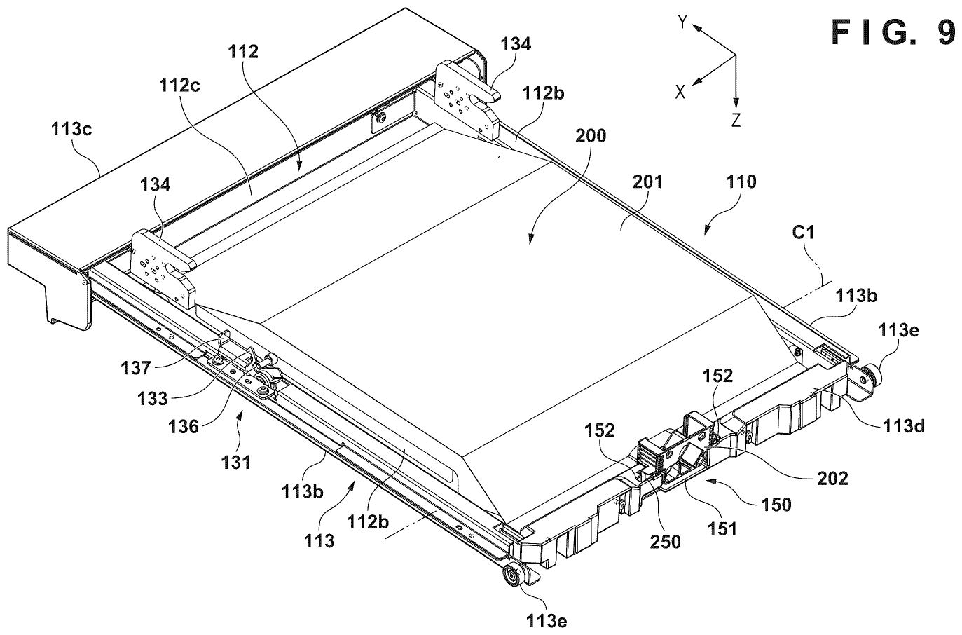

FIGS. 5 and 9 will be referred to. FIG. 9 is a perspective view of the tray 110 on which the liquid container 200 is placed. The containing part 201 of the liquid container 200 is placed on the placement member 112. A part of the containing part 201 on the side of the connecting part 202 is placed on the tray main body 113, and the rotation centerline C1 is apart from the connecting part 202 in the Y direction and passes through the containing part 201.

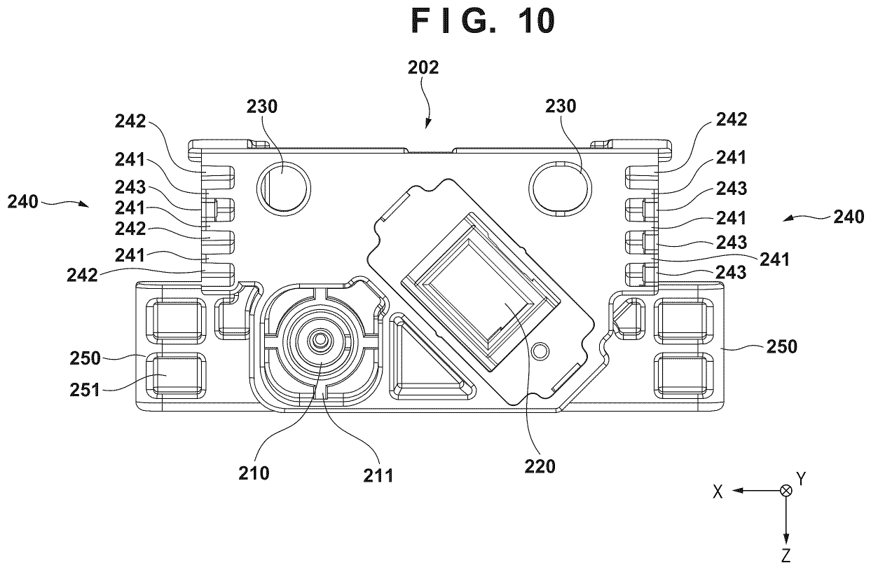

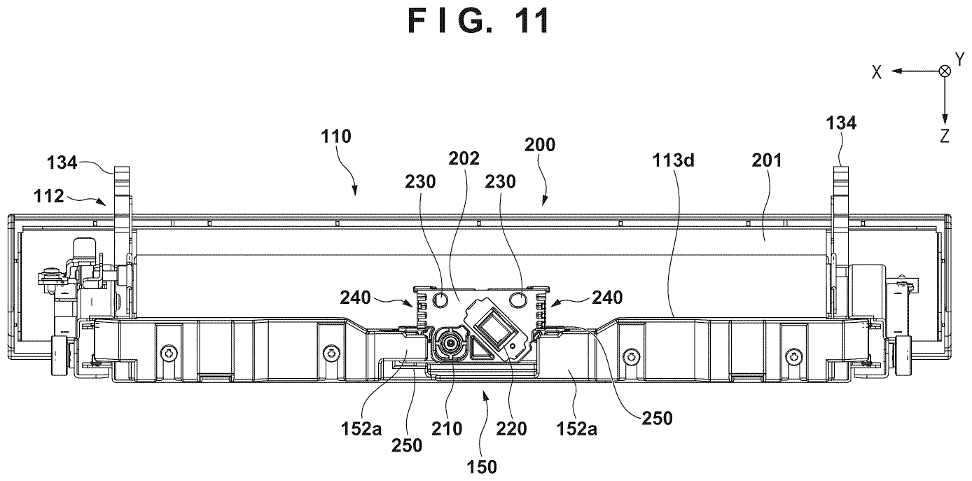

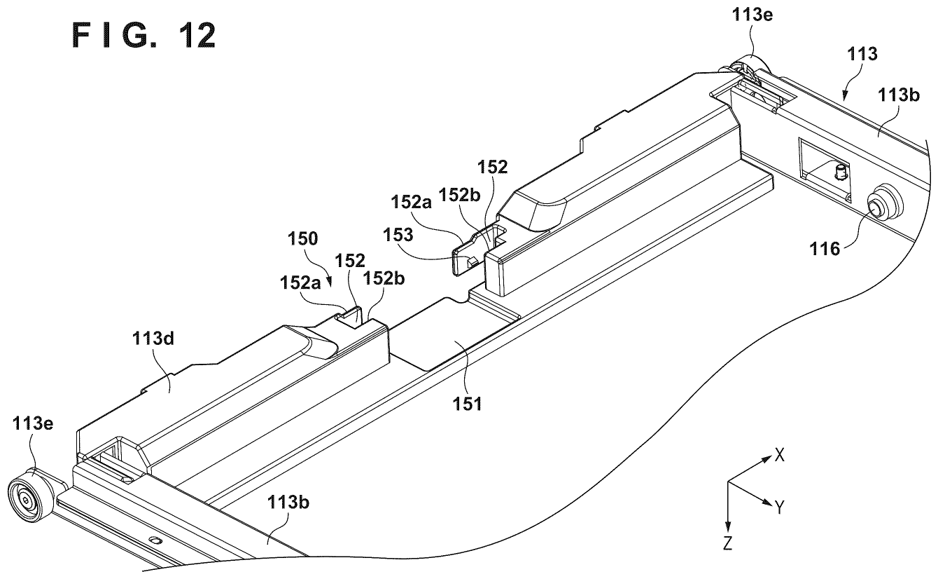

A holding part 150 that holds the connecting part 202 of the liquid container 200 is formed at the central portion of the rear wall part 113d in the X direction. The structure of the connecting part 202 and the holding part 150 will be described with reference to FIGS. 10 to 12 in addition to FIGS. 5 and 9. FIG. 10 is a front view of the connecting part 202 viewed in the Y direction. FIG. 11 is a view of the tray 110 with the liquid container 200 placed thereon viewed from the side of the rear wall part 113d in the Y direction. FIG. 12 is a perspective view of the periphery of the holding part 150.

The holding part 150 includes a concave part 151 that is recessed downward from the upper surface of the rear wall part 113d in the Z direction, and engaging parts 152 formed on both sides of the concave part 151 in the X direction. Each engaging part 152 is a groove extended in the Z direction and having a depth in the X direction, and is formed by vertical walls 152a and 152b apart in the Y direction. Left and right engaging parts 250 of the connecting part 202 are inserted into the engaging parts 152 in the Z direction, and the remaining part of the connecting part 202 is arranged on the concave part 151. The engaging parts 250 are plate-shaped members projecting to both sides of the connecting part 202 in the X direction.

The holding part 150 positions the connecting part 202 with respect to the tray 110 in the X, Y, and Z directions. Also, since each engaging part 152 includes the pair of vertical walls 152a and 152b apart in the Y direction, displacement of the engaging parts 250 in the Y direction is regulated. As a result, displacement of the connecting part 202 in the Y direction is regulated by the engaging parts 152 with respect to the tray 110.

The engaging parts 250 are the side portions of the connecting part 202 and are arranged on the lower side. The connecting part 202 substantially has a convex shape projecting upward on the XZ plane and has a convex shape projecting in the Y direction on the XY plane. The Z-direction width of the engaging part 152 equals that of the engaging part 250, and the connecting part 202 projects upward in the Z direction from the periphery of the holding part 150. The user can thus easily pinch the connecting part 202 and easily detach the connecting part 202 from the concave part 151. When exchanging the liquid container 200 in the tray 110, the convenience of the exchange work can be improved.

Also, an engaging part 153 is formed on the vertical wall 152a of each engaging part 152. The engaging part 153 is a projection projecting from the vertical wall 152a in the Y direction. Each engaging part 250 includes an engaging part 251 that engages with the engaging part 153. The engaging part 251 is formed as a hole extending through the engaging part 250 in the Y direction or a concave portion recessed in the Y direction.

When attaching the liquid container 200 to the tray 110, the lower surfaces of the engaging parts 250 contact the surfaces (tilting surfaces) of the engaging parts 153 during the process of insertion of the engaging parts 250 into the engaging parts 152. Thus, the vertical walls 152a of the engaging parts 152 are elastically displaced to the rear side in the Y direction. When insertion of the engaging parts 250 into the engaging parts 152 progresses, the engaging parts 153 reach the engaging parts 251. Thus, the vertical walls 152a return to the original positions, and the engaging parts 153 engage with the engaging parts 251.

The engaging direction between the engaging part 153 and the engaging part 251 is the Z direction, and this is different from the attachment/detachment direction (Y direction) of the tray 110 to/from the storage unit 101. This can prevent the connecting part 202 from falling from the holding part 150 at the time of attachment/detachment of the tray 110.

### (Channel Connection Structure)

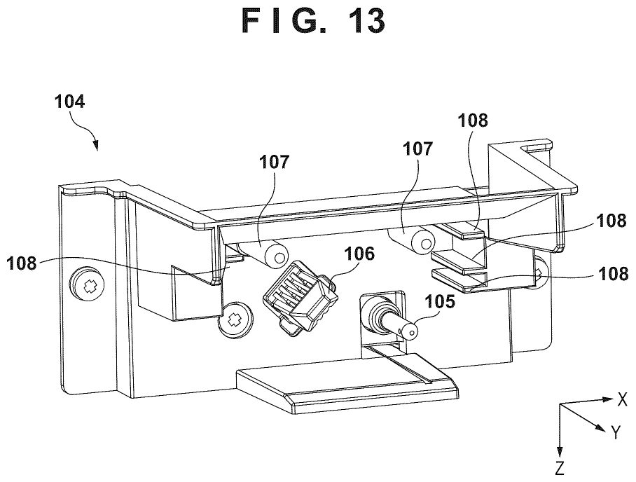

The connection structure between the connecting part 202 of the liquid container 200 and the connecting unit 104 of the storage unit 101 will be described with reference to FIGS. 3, 10, and 13. FIG. 13 is a perspective view of the connecting unit 104. The connecting part 202 of the liquid container 200 is connected to the connecting unit 104 by attaching the tray 110 with the liquid container 200 mounted to the storage unit 101 and pushing it to the far side. Reversely, when the tray 110 with the liquid container 200 mounted is drawn from the storage unit 101 to the near side, the connection between the connecting part 202 and the connecting unit 104 is canceled.

The connecting part 202 is formed by, for example, molding a resin member such as polypropylene. The connecting part 202 is provided with a connecting hole 210, an electrical connecting part 220, a plurality of positioning holes 230, and fitting parts 240. The connecting unit 104 includes a tube connecting pipe 102 (FIG. 3) extended to the outside of the storage unit 101, and a tube to be connected to a buffer tank is connected to the tube connecting pipe 102. These form an ink channel. The ink stored in the liquid container 200 is supplied to the printhead 22 via the buffer tank.

The connecting hole 210 is an opening part of the channel that is open in the Y direction and communicates with the inside of the containing part 201. The center axis of the connecting hole 210 is parallel to the Y direction. An introduction pipe 105 of the connecting unit 104 is connected to the connecting hole 210 in the Y direction. The introduction pipe 105 communicates with the tube connecting pipe 102, and the ink in the liquid container 200 is discharged via the connecting hole 210 and the introduction pipe 105.

Note that a structure configured to prevent ink leakage can be provided inside the connecting part 202. This structure may be a valve structure or seal structure that maintains a closed state before the introduction pipe 105 is inserted into the connecting hole 210 and opens when the introduction pipe 105 is inserted.

In this embodiment, in the connecting part 202, a peripheral part 211 of the connecting hole 210 is recessed in the Y direction as a whole, and the connecting hole 210 opens at a position where it projects in the Y direction with respect to the peripheral part 211. Thus, the periphery of the connecting hole 210 is surrounded by a wall part formed by the peripheral part 211, and protectability of the connecting hole 210 is improved. For example, user's touch on the connecting hole 210 by mistake is suppressed. Also, when the liquid container 200 falls by mistake, degradation such as damage or deformation of the connecting hole 210 caused by collision is suppressed. A peripheral rib that is provided to surround the connecting hole 210 and project in the Y direction may be formed on the peripheral part 211.

An electrical connecting part 106 of the connecting unit 104 is inserted into the electrical connecting part 220 in the Y direction and structurally connected and electrically connected to it. The electrical connecting part 220 includes a circuit board and an electrical connecting terminal. The circuit board includes a memory that stores information of the liquid container 200, and the like. By the electrical connection of the electrical connecting part 220 and the electrical connecting part 106, the control unit 21 can read out the information in the memory.

A shaft member 107 of the connecting unit 104 is inserted into each positioning hole 230. The connecting part 202 and the connecting unit 104 are positioned to each other. In this embodiment, two sets of positioning holes 230 and shaft members 107 are provided apart in the X direction, and the connecting hole 210 and the introduction pipe 105 are arranged between these in the X direction. This improves positioning accuracy of the connecting hole 210 to the introduction pipe 105 in the X direction.

In this embodiment, the type of liquid container 200 to be stored in each storage unit 101 (or the type of ink to be stored) is predetermined. The fitting parts 240 structurally prevent the liquid container 200 of a different type from being erroneously attached to the storage unit 101.

The fitting parts 240 are formed on the connecting part 202 divisionally in the X direction. The fitting parts 240 project in the same length in the X direction and each have a concave-convex structure in which a plurality of projecting parts 241 having a substantially rectangular shape and parallelly extending in the −Y direction are arrayed. Sealing parts 243 are arranged in a predetermined pattern on valley parts 242 that are concave parts between the projecting parts 241 in the fitting part 240. The sealing part 243 is a portion that closes the valley part 242, and the arrangement pattern of the sealing parts 243 changes depending on the type of liquid container 200.

Fitting parts 108 to be fitted in the fitting parts 240 are provided on the connecting unit 104. The valley parts 242 are sealed by arranging the sealing parts 243, and the concave and convex portions in the arrangement pattern of the concave-convex structure of each fitting part 240 are reverse to those in the array pattern of the concave-convex structure of the corresponding fitting part 108 that is the connection target. When connecting the connecting part 202 to the connecting unit 104, if the type of liquid container 200 matches, fitting between the concave-convex structures of the fitting parts 108 and the concave-convex structures of the fitting parts 240 is permitted. On the other hand, if the type of liquid container 200 does not match, the concave-convex structures of the fitting parts 108 are not adapted to the concave-convex structures of the fitting parts 240, and fitting is impossible. Hence, connection of a wrong liquid container 200 to the connecting unit 104 is suppressed.

### (Other Trays)

The tray 110 and the tray 111 basically have the same structure. The tray 110 has a structure for stirring ink in the liquid container 200, but not the tray 111. For this reason, the tray 111 does not include the placement member 112 (and engaging parts) and the lock mechanism 131.

### (Rotation Unit and Stirring of Liquid)

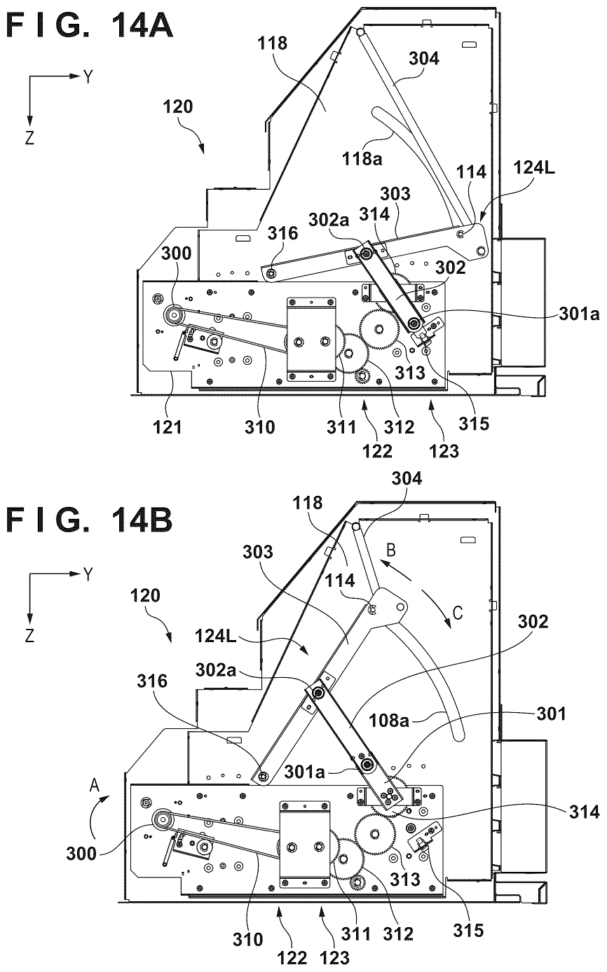

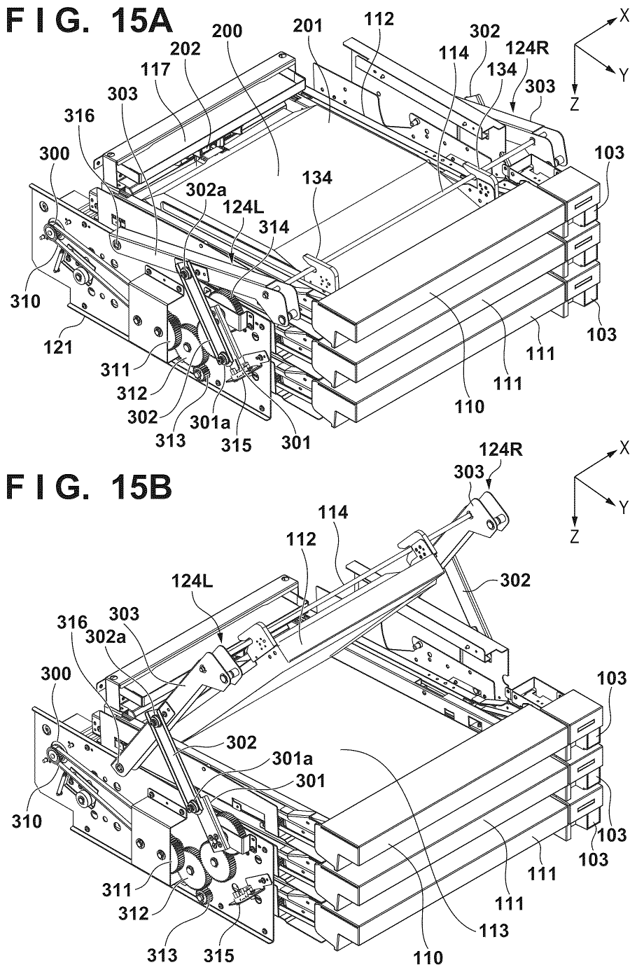

In this embodiment, the liquid container 200 placed on the tray 110 is rotated, thereby stirring the ink stored in the liquid container 200. In this embodiment, the liquid container 200 is rotated by rotating the placement member 112. The configuration of the rotation unit 120 that rotates the placement member 112 will be described with reference to FIG. 2 and FIGS. 14A to 15B. FIGS. 14A and 14B and FIGS. 15A and 15B are operation explanatory views of the rotation unit 120.

FIGS. 14A and 15A show the state of the rotation unit 120 when the placement member 112 is located at an initial position, and FIGS. 14B and 15B show the state of the rotation unit 120 in a case where the placement member 112 is located at a maximum rotation position from the initial position. The initial position is a position at which the tray 110 can be inserted/removed into/from the storage unit 101, and the entire tray 110 and the liquid container 200 are in a substantially horizontal posture (the side of the connecting part 202 is lightly lower). The maximum rotation position is a position at which the rotation amount of the placement member 112 is maximum and, in this embodiment, it is a position about 45° from the initial position. At the maximum rotation position, the tray 110 cannot be inserted/removed into/from the storage unit 101. Concerning the posture of the containing part 201 of the liquid container 200, the containing part 201 is close to horizontal at the initial position as compared to the maximum rotation position.

The rotation unit 120 is provided for each of the two storage units 101 of the uppermost stage. The rotation unit 120 includes a driving source 300, a driving mechanism 122 that rotates the placement member 112 by the driving force of the driving source 300, and a biasing member 304.

The driving source 300 is, for example, a stepping motor. In the drawings, the main body of the driving source 300 is hidden behind the base plate 121, and only a part thereof is shown. The rotation amount of the placement member 112 can be controlled by the rotation amount of the driving source 300. The driving source 300 may be a DC motor. In this case, to control the rotation amount, a rotation amount sensor such as a rotary encoder may be provided.

The driving mechanism 122 is a driving force transmission mechanism that rotates the placement member 112 by the driving force of the driving source 300, and is a conversion mechanism that converts the driving force of the driving source 300 into the rotary motion of the placement member 112. In this embodiment, the driving mechanism 122 includes a gear device 123, and a pair of link mechanisms 124R and 124L. The configuration of the driving mechanism 122 is merely an example, and it may be a mechanism of another method.

The driving source 300 and the gear device 123 are mounted on the base plate 121 arranged on one side portion of the storage unit 101 in the X direction. The rotation force of the driving source 300 is transmitted to the gear device 123 via a belt transmission mechanism 310. The gear device 123 includes a gear 311 that is rotated by the belt transmission mechanism 310, a gear 312 that meshes with the gear 311, a gear 313 that meshes with the gear 312, and a gear 314 that meshes with the gear 313.

The pair of link mechanisms 124R and 124L are divisionally arranged on the side portions of the storage unit 101 in the X direction. The link mechanism 124L is arranged on the side of the driving source 300, and the link mechanism 124R is arranged on the opposite side. The link mechanism 124L is a mechanism on the driving side, and the link mechanism 124R is a mechanism on the driven side. These basically have the same configuration and form a crank mechanism to be described below.

The pair of link mechanisms 124R and 124L each include arm members 301 to 303. The arm member 301 rotates around one end portion thereof as the rotation center, and the other end portion is rotatably connected to one end portion of the arm member 302 via a shaft 301a. One end portion of the arm member 301 of the link mechanism 124L is coaxially fixed to the gear 314 and rotates together with the gear 314. One end portion of the arm member 301 of the link mechanism 124R is supported to be free to rotate, although not illustrated.

The other end portion of the arm member 302 is rotatably connected to the intermediate portion of the arm member 303 via a shaft 302a. A pair of side plates 118 are arranged on both side portions of the storage unit 101 in the X direction. One end portion of the arm member 303 is rotatably supported on the side plate 118 via a shaft 316. The shaft 316 is located on the same axis as the rotation centerline C1 (FIG. 5) so that the rotation of the placement member 112 synchronizes with the rotation of the arm member 303.

A guide hole 118a that has an arc shape and defines the swing track of a swing shaft 114 is formed in the side plate 118. The swing shaft 114 is extended across the storage unit 101 in the X direction. The swing shaft 114 is disposed between the other end portions of the arm members 303 of the link mechanisms 124R and 124L.

In a state in which the tray 110 is attached to the storage unit 101, the swing shaft 114 engages with the engaging part 134. Since the engaging part 134 has a C shape open to one side (rear side) in the Y direction, at the time of attachment/detachment of the tray 110, the swing shaft 114 does not hinder it. When the tray 110 is attached to the storage unit 101, the swing shaft 114 engages with the engaging part 134 in the Z direction. When the tray 110 is detached from the storage unit 101, the engagement between the swing shaft 114 and the engaging part 134 is canceled.

The biasing member 304 is provided between the other end portion of the arm member 303 of the link mechanism 124L and the adjacent side plate 118. The biasing member 304 is an elastic member such as a coil spring and generates a biasing force to the arm member 303 in a direction in which the placement member 112 is located at the maximum rotation position. A similar biasing member may be provided between the other end portion of the arm member 303 of the link mechanism 124R and the adjacent side plate 118.

In FIG. 14B, if the driving source 300 is one-directionally driven in the direction of an arrow A, the rotary motion of the motor shaft is converted into the swing motion of the swing shaft 114 via the driving mechanism 122, and the swing shaft 114 is reciprocally continuously operated in the directions of arrows B and C. Along with the operation of the swing shaft 114, the placement member 112 and the liquid container 200 set in it rotate, and the ink stored in the liquid container 200 is stirred. As handling to the stirring, the placement member 112 may be rotated continuously between the initial position and the maximum rotation position, or may be stopped at the maximum rotation position or the initial position for a predetermined time and rotated.

The biasing member 304 is configured to bias the placement member 112 to the maximum rotation position. Rotation of the placement member 112 from the initial position to the maximum rotation position is executed by the driving force of the driving source 300, and the biasing member 304 generates a force (biasing force) for assisting the operation. A sensor 315 is a sensor that detects the posture of the placement member 112. The sensor 315 is an optical sensor configured to detect the position of the arm member 301, and is arranged to detect the arm member 301 when the placement member 112 is at the initial position.

If the tray 110 is not attached to the storage unit 101 or at the time of exchange of the liquid container 200, the driving force of the driving source 300 is maintained in such a state that it can resist the biasing force of the biasing member 304 in a state in which the placement member 112 is located at the initial position. The placement member 112 is thus held at the initial position. With this configuration, the insertion/removal operation of the tray 110 is possible. To maintain the driving force of the driving source 300 in such a state that it can resist the biasing force of the biasing member 304, for example, if a stepping motor is used, a state in which a torque is generated such that the shaft is not rotated is maintained (an excited state is set). The sensor 315 is not limited to an optical sensor, and an encoder sensor that detects an angle or a sensor of another method of directly detecting the placement member 112 may be used.

Note that if driving of the driving source 300 is absent, the placement member 112 is located between the initial position and the maximum rotation position. However, the position varies depending on the amount of ink in the liquid container 200. If the amount of ink is large, the placement member 112 is located at a position close to the initial position. If the amount of ink is small, the placement member 112 is located at a position close to the maximum rotation position. If the amount of ink is very large because, for example, the liquid container 200 is new, the placement member 112 may be located at the initial position.

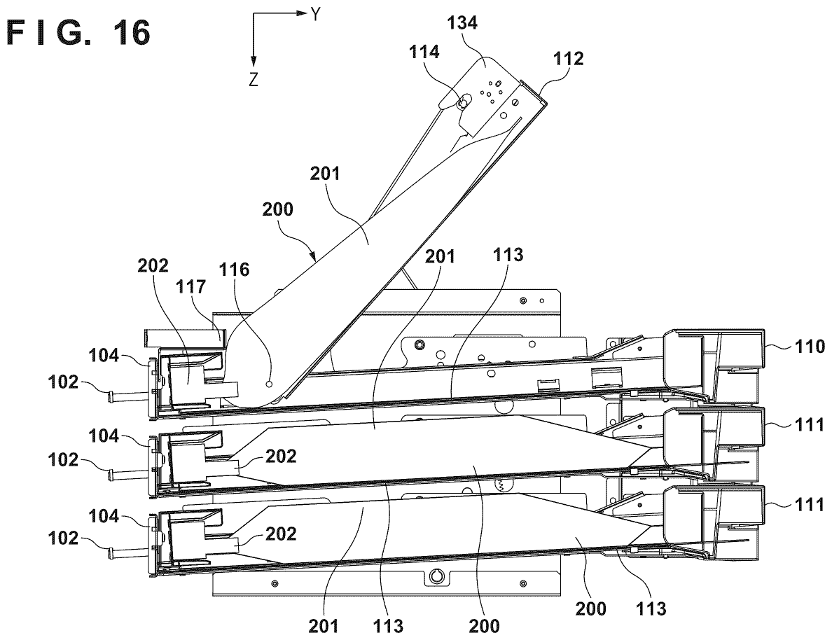

The posture of the liquid container 200 at the time of stirring will be described. FIG. 16 is a view showing the posture of the liquid container 200 at the maximum rotation position. According to the configuration of this embodiment, the containing part 201 of the liquid container 200 is rotated with respect to the connecting part 202, and the connecting part 202 itself substantially stands still. More specifically, the rotation centerline C1 of the placement member 112 is apart from the connecting part 202 in the Y direction and passes through the containing part 201. Hence, the liquid container 200 does not rotate as a whole, and the containing part 201 rotates such that the liquid container 200 is bent with respect to the rotation centerline C1 as the boundary. Also, the connecting part 202 is held by the holding part 150, and additionally, a regulating member 117 that regulates the displacement of the connecting part 202 is provided above the connecting part 202. The regulating member 117 regulates the displacement of the connecting part 202 in a direction (the Z direction in this embodiment) crossing the connection direction (the Y direction in this embodiment) between the connecting part 202 and the connecting unit 104. Because of the existence of the regulating member 117, even if the connecting part 202 is going to rise upward during the stirring operation, the displacement is regulated as it abuts against the regulating member 117.

With this structure, the connecting part 202 itself substantially stands still and, therefore, the connecting unit 104 also stands still. The tube connected to the tube connecting pipe 102 of the connecting unit 104 is not repetitively deformed. This also has little effect on the connection state between the connecting part 202 and the connecting unit 104. It is therefore possible to suppress fatigue of a member that forms such a channel.

### OTHER EMBODIMENTS

The operation direction of the lock member 133 engaging with or disengaging from the engaging part 136 in the operation of the lock mechanism 131 is not limited to the above-described example. Instead of rotating in the rotation direction RR or RL, the lock member 133 may rotate using the Z direction as the rotation axis or slide in the Y direction.

In addition, the operation form of unlocking the lock mechanism 131 is not limited to the above-described example. In place of an operation form of unlock by the unlock member 137 along with the insertion operation of the tray 110, the lock mechanism 131 may be unlocked along with the lock operation of the operation member 103.

Also, the configuration of setting the liquid container 200 in the tray 110 is not limited to the above-described configuration. For example, in the rear wall part 113d, only the peripheral part of the holding part 150 need not be recessed in the Z direction. The whole region of the rear wall part 113d may be at the same height as the height of the engaging parts 250. Even in this configuration, in a state in which the liquid container 200 is arranged on the tray 110, the connecting part 202 projects in then Z direction on the periphery of the holding part 150. Hence, the user can hold the projecting connecting part 202.

Also, the tray 110 may have a shape projecting upward in the Z direction, and the connecting part 202 may have a concave shape corresponding to the projecting shape or a through hole shape and may be guided in attachment. In this case, for example, a plurality of guide structures may be provided, and these may be apart from each other in the X direction.

In addition, the engaging parts 251 may be provided at positions different from the engaging parts 250 in the connecting part 202. In this case, for example, the engaging parts 251 may be provided on the lower portion or on the side surface portions such that, for example, these hardly impede the operation of the user.

In addition, the engaging parts 152 and the engaging parts 250 may be provided at different portions. For example, these may be provided on both sides of the tray 110 in the X direction. Alternatively, a plurality of engaging parts may be provided in the Z direction. This can increase the engaging force and stabilize these.

Also, the engaging parts 153 may have a configuration other than that of the embodiment. For example, a structure including an elastic member such as a spring may be provided on the rear wall part 113d, and this may be engaged in guiding. Alternatively, a movable member that can engage with the engaging part 251 may be provided on the rear wall part 113d and engaged by a user operation after guide.

Also, the engaging part 153 and the engaging part 251 may be provided on a part of one surface or the other surface of the rear wall part 113d and the connecting part 202 in the X direction, and the engaging part 152 may engage by displacing in the X direction at the time of guide. Additionally, a structure in which the engaging part 251 is displaced to engage at the time of guide may be provided.

The placement member 112 may rotate from the initial position close to a horizontal posture to the lower side. This can improve the efficiency of stirring a pigment that has sedimentability and settles down around the connecting part 202. In this configuration, the tray 110 is attached/detached to/from the storage unit of the lowermost stage among the plurality of storage units 101 arranged in the vertical direction, and the ink in the liquid container 200 mounted on the tray 110 may be stirred. The rotation direction of the placement member 112 may be not the up/down direction but the left/right direction. The placement member 112 may be stopped at a plurality of rotation positions.

Also, as the configuration for rotating the placement member 112, the placement member 112 may be rotated only by the arm member 303, a cam may be used, or another mechanism such as a mechanism using a linear actuator may be used.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-190070, filed Oct. 29, 2024, which is hereby incorporated by reference herein in its entirety.

What is claimed is:

1. A liquid supply apparatus comprising:
a liquid container including a containing part having flexibility, and a connecting part provided at an end portion of the containing part;
a channel connected to the connecting part and configured to flow a liquid out of the liquid container;
a rotation unit configured to rotate the containing part with respect to the connecting part; and
a regulating unit configured to regulate displacement of the connecting part in a direction crossing a connection direction between the connecting part and the channel.

2. The apparatus according to claim 1, wherein
the containing part includes a first end portion provided with the connecting part, and a second end portion on an opposite side of the first end portion, and
the rotation unit is configured to rotate the containing part with respect to the connecting part about a position apart from the connecting part to a side of the second end portion as a rotation center.

3. The apparatus according to claim 1, wherein
the rotation unit is configured to rotate the containing part in an up/down direction.

4. The apparatus according to claim 3, wherein
the rotation unit rotates the containing part between a first position and a second position, and
the first position is a position at which the containing part is close to horizontal as compared to the second position.

5. The apparatus according to claim 1, further comprising a plurality of storage units arranged in an up/down direction and each capable of storing the liquid container,
wherein the rotation unit is configured to rotate the containing part of the liquid container stored in a storage unit of an uppermost stage with respect to the connecting part.

6. The apparatus according to claim 1, further comprising a storage unit capable of storing the liquid container,
wherein the liquid container is placed on a tray and detachably stored in the storage unit,
the tray comprises:
a tray main body; and
a placement member which is rotatably supported by the tray main body and on which the containing part is placed, and
the rotation unit is configured to rotate the placement member.

7. The apparatus according to claim 6, wherein
the placement member is rotated between a first position and a second position,
at the first position, a bottom wall part of the placement member abuts against the tray main body, and
at the second position, the bottom wall part of the placement member separates from the tray main body.

8. The apparatus according to claim 7, wherein
in a state in which the tray is extracted from the storage unit, the placement member is located at the first position.

9. The apparatus according to claim 8, wherein
the tray comprises a lock unit configured to lock the placement member to the first position, and
lock of the placement member by the lock unit is canceled by attaching the tray to the storage unit.

10. The apparatus according to claim 9, wherein
the lock unit comprises a movable member configured to be displaceable to a lock position at which the placement member to is locked to the first position and an unlock position at which the lock is canceled, and
the storage unit comprises an operation member configured to abut against the movable member when the tray is attached to the storage unit and displace the movable member to the unlock position.

11. The apparatus according to claim 7, wherein
the rotation unit comprises:
a driving source;
a driving mechanism configured to rotate the placement member by a driving force of the driving source; and
a biasing member configured to bias the placement member to the second position.

12. The apparatus according to claim 11, wherein
the placement member rotates from the second position to the first position by driving of the driving source.

13. The apparatus according to claim 6, wherein
the tray comprises a holding part provided on the tray main body and configured to hold the connecting part.

14. The apparatus according to claim 13, wherein
in a state in which the connecting part is held by the holding part, a part of the connecting part projects from a periphery of the holding part of the tray.

15. The apparatus according to claim 13, wherein
the connecting part and the holding part engage with each other in a direction different from an attachment/detachment direction of the tray to/from the storage unit.

16. A system comprising a liquid discharge apparatus for discharging a liquid, and a liquid supply apparatus for supplying the liquid from a liquid container including a containing part having flexibility, and a connecting part provided at an end portion of the containing part to the liquid discharge apparatus,
wherein the liquid supply apparatus comprises:
a channel connected to the connecting part and configured to flow the liquid out of the liquid container;
a rotation unit configured to rotate the containing part with respect to the connecting part; and
a regulating unit configured to regulate displacement of the connecting part in a direction crossing a connection direction between the connecting part and the channel.
